(19) United States
(12) Patent Application Publication
(10) Pub. No.: US 2009/0137728 A1
(43) Pub. Date: May 28, 2009

(54) Low blush gelcoats having high color fastness

(75) Inventors: Michael J. Sumner, Dublin, OH (US); Charles L. Fisher, Ostrander, OH (US); Robin F. Righettini, Dublin, OH (US)

Correspondence Address: ASHLAND LICENSING AND INTELLECTUAL PROPERTY, LLC, 5200 BLAZER PARKWAY, DUBLIN, OH, 43017, US

(73) Assignee: Ashland Licensing and Intellectual Property LLC, Dublin, OH (US)

(21) Appl. No.: 12/228,820

(22) Filed: Aug. 15, 2008

Related U.S. Application Data
(60) Provisional application No. 60/966,802, filed on Aug. 30, 2007.

(51) Int. Cl. C08L 31/02

(52) U.S. Cl. 524/563; 524/556

(57) ABSTRACT

Gelcoat compositions comprising a base resin, a reactive diluent component, a pigment and more than about 2% by weight inorganic extended fillers wherein the reactive diluent component either a) comprises styrene and one or more alternative reactive diluents or b) consists of one or more alternative reactive diluents. Also, disclosed is watercraft made with these gelcoat compositions. Further, a process for making gelcoat compositions is disclosed wherein some or all of the styrene in the reactive diluent component is replaced with one or more alternative reactive diluents.

### CROSS-REFERENCE TO RELATED APPLICATIONS

This application claims the benefit of U.S. Patent Application No. 60/966,802, filed Aug. 30, 2007. U.S. Patent Application No. 60/966,802 is incorporated herein in its entirety by reference.

### BACKGROUND OF THE INVENTION

1. Field of the Invention

The invention concerns gelcoat compositions comprising a base resin, a reactive diluent component, a pigment and inorganic extended fillers. The gel coat compositions may further comprise promoters, accelerators, thixotropic agents, promoters, inhibitors, air release agents, flow and leveling agents, dispersing aids and the like. The gelcoat composition is particularly useful in the manufacture of marine equipment, such as pleasure watercraft, like boats, yachts, jet skis and other personal watercraft.

2. Background of the Invention

In the composites industry, fiber-reinforced components or parts are often coated or “gelcoated” to improve the overall quality of the part. The fiber-reinforced components are manufactured by initially coating the interior of a mold, which is the negative image or shape of the final part, using a gelcoat. The gelcoat is applied in a relatively thick layer of from 10 to 40 thousandths of an inch, typically using spray gun technology. In some instances, it is applied using brushing or hand lay-up.

After the gelcoat is allowed to solidify or cure, it is reinforced using a fiber-reinforced laminating resin that is applied using various techniques (brushing, spraying, hand lay-up). The laminating resin is allowed to cure and the final part is removed from the mold. As the laminating resin is curing, the resin will shrink around the fibers and a fiber pattern will appear. The appearance of the fiber pattern is often referred to as “print-through”.

In the composite manufacturing process, the gelcoat is applied in part to hide the print-through, which allows the final part to have a high quality surface appearance. In addition, a gelcoat can provide a high quality cosmetic appearance. The gelcoat also serves as a barrier against water, wear, and weathering.

In the marine manufacturing industry, pigmented gelcoat is used heavily in the manufacture of various types of composite pleasure craft, examples of which include speed boats and yachts. Currently, consumers are demanding composite boats with color composite parts having greater color and gloss retention or fastness over time. Conventional gelcoats pigmented to other colors, especially dark colors, were not traditionally used below the water line because the pigmented gelcoat would become lighter in color or “blush” due to exposure to the marine environment. Thus, historically, white pigmented gelcoats have been predominately used for composite boat applications, especially below the water line. The boat manufacturing industry is responding to consumer demand by placing higher performance requirements on gelcoat in terms of gloss retention and color fastness as a function of exposure time to the marine/aquatic environment. White gelcoats do not tend to color change due to blushing, however white material, particularly in a marine environment, suffers from gloss loss and yellowing due to environmental exposure. Thus, non-pigmented, or white, gelcoats that do not experience gloss loss and yellowing are also desired by the boat manufacturing industry.

Gelcoat is mainly made from an unsaturated polyester base resin, promoters, accelerators, inorganic extender fillers, reactive diluents such as styrene, and pigments. It is said in U.S. Published Application 2007/0001343 that drastically reducing the inorganic extender filler level to about 2 wt % or less can reduce “blushing”. However, reducing the filler level in a gelcoat causes problems in processing and application. Two problems typically associated with gelcoats containing low amounts of filler are sagging and porosity. Sagging occurs when a gelcoat is sprayed onto the vertical surface of a mold and, due to gravity, the gelcoat begins to slowly sag. This negatively impacts final part quality and is unacceptable to the boat manufacturer. Porosity is the result of air voids being trapped permanently in the gelcoat during the cure cycle. Boat manufacturers often have to repair hulls of boats because of damage suffered at the manufacturing facility or in the field. Therefore, being able to repair a boat is critical to the boat manufacturer. Repairing involves sanding, patching, and buffing the damaged area of the hull. Voids trapped beneath the surface of the gelcoat make the repair process very difficult and is unacceptable to boat manufacturers.

Porosity in gelcoats comprising a relatively low amount of fill can typically be eliminated by including materials that increase the level of hazardous air pollutants (“HAPS”) in the formulation, such as styrene and methylmethacrylate. However, the increase in HAPS will render the gelcoat not compliant with United States federal government Maximum Achievable Control Technology (“MACT”) standards, and similar standards and procedures in other countries, which is often deemed unacceptable by boat manufacturers.

All parts and percentages set forth in this specification and the claims are on a weight-by-weight basis unless otherwise specified.

### SUMMARY OF THE INVENTION

The invention provides for the use of alternative monomers, i.e. alternative reactive diluents, in gelcoat compositions with a commensurate reduction or elimination of styrene and the use of relatively larger amounts of filler, such as more filler than that allowed for in U.S. Published Application 2007/0001343. The gelcoat compositions are either white or pigmented and are MACT compliant, with excellent color fastness and decreased sagging and porosity. In aspects of the invention, sagging and porosity is eliminated.

In an embodiment of the invention, the gel coat composition comprises a reactive diluent comprising styrene and one or more alternative diluents. In a further embodiment, the gel coat composition comprises a reactive diluent component that does not comprise styrene and consists of one or more alternative reactive diluents.

### DETAILED DESCRIPTION OF THE DRAWINGS

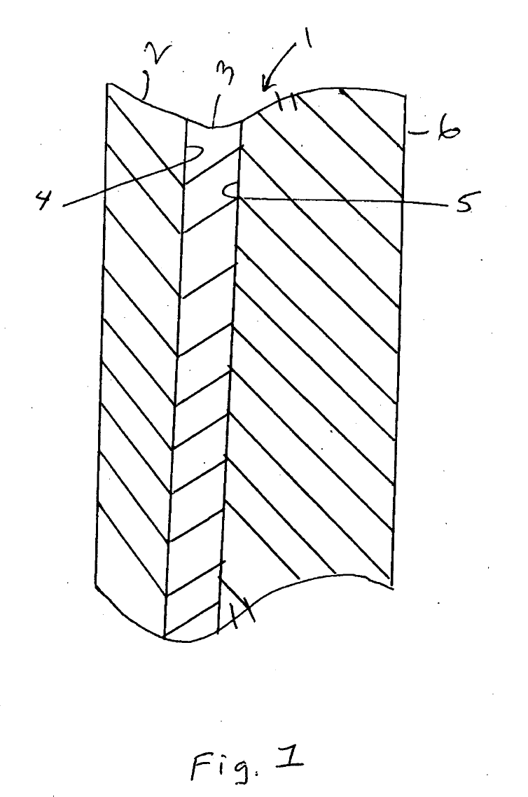

FIG. 1 is a cross-sectional view of a laminated reinforced compound compromising the gelcoat composition in accordance with an embodiment of the invention.

### DETAILED DESCRIPTION OF THE INVENTION

The gelcoat compositions comprise a base resin, reactive diluents, pigment and inorganic extended fillers and may further comprise one or more of promoters, accelerators, thixotropic agents, inhibitors, air release agents, flow and leveling agents and dispersing aids. Typically, The gelcoat compositions may comprise about 40% to about 80%, preferably from about 50% to about 70%, base resin; about 10% to about 45% reactive diluents; up to about 20%, such as about 1% to about 20%, pigment and more than about 2% inorganic extended fillers. The gel coat composition may further comprise up to about 1%, preferably from about 0.1% to about 1%, promoters; up to about 1%, preferably from about 0.1% to about 1%, accelerators; up to about 1%, preferably from about 0.1% to about 1%, thixotropic agents; up to about 1%, preferably from about 0.1% to about 1%, inhibitors; up to about 1%, preferably from about 0.1% to about 1%, air release agents, up to about 1%, preferably from about 0.1% to about 1%, flow and leveling agents and up to about 1%, preferably from about 0.1% to about 1%, dispersing aids The gelcoat compositions can be applied in methods for making composite materials, such as boat hulls and other parts for marine equipment, typically parts that will be partially or completely submerged in water.

The base resins useful in the invention include unsaturated polyester resin, urethane modified unsaturated polyester resins, vinyl ester resins, and the like. The polyester resins used herein can be prepared from the condensation of one or more carboxylic acids, such as mono-, di-, or polyfunctional unsaturated or saturated carboxylic acids or their corresponding anhydrides, and one or more mono-, di-, or other polyfunctional alcohols. Representative unsaturated carboxylic acids and their corresponding anhydrides include maleic acid, fumaric acid, chloromaleic acid, itaconic acid, citraconic acid, methylene glutaric acid, mesaconic acid, acrylic acid, methacrylic acid, and mixtures thereof. Representative saturated carboxylic acids and their corresponding anhydrides include succinic acid, glutaric acid, d-methyl glutaric acid, adipic acid, sebacic acid, pimelic acid, phthalic anhydride, o-phthalic anhydride, isophthalic acid, terephthalic acid, and mixtures thereof.

Representative alcohols for use in making the unsaturated polyester resins include alkanediols and oxa-alkanediols such as ethylene glycol, 1,2-propylene glycol, propane-3-diol, 1,3-butylene glycol, butene-1,4-diol, hexane-1,6-diol, diethylene glycol, triethylene glycol, polyethylene glycol, cyclohexane-1,2-diol, 5-norbornene-2,2-dimethylol, 2,3-norbornene diol, cyclohexane dimethanol, 1,2-propanediol, 2-methy 1-,3-propanediol, pentaerythritol and mixtures thereof. Representative monofunctional alcohols that can be used in limited amounts, such as about 0.5% to about 10%, include benzyl alcohol, cyclohexanol, 2-ethyhexyl alcohol, 2-cyclohexyl ethanol, lauryl alcohol and mixtures thereof.

Modified unsaturated polyester resins can be used in the gelcoat compositions an example of which includes resins formed by reacting an oligoester having a weight average molecular weight of about 200 to about 4,000 with a diisocyanate and a hydroxyalkyl(meth)acrylate to provide a urethane acrylate having terminal vinyl groups.

Vinyl esters may be used as a base resin in the gelcoat compositions, typically vinyl ester based upon bisphenol A diepoxide. Examples of acceptable vinyl ester resins of this type include the DERAKANE® vinyl ester resin products available though Ashland Inc., Dublin, Ohio, U.S.A. Other types of vinyl esters include those based on cycloaliphatic and/or linear aliphatic diepoxides. Examples of cycloaliphatic vinyl esters include those prepared using hydrogenated bisphenol A and cyclohexane. Examples of linear aliphatic vinyl esters include those prepared from neopentyl, propylene, dipropylene, polypropylene, polyethylene, and diethylene glycol diepoxides.

The base resins used in the gelcoat compositions can be prepared by techniques familiar to those skilled in the art. For example the unsaturated polyester resins useful in the gelcoat compositions described herein can be prepared by common esterification techniques where the carboxylic acid or corresponding anhydride is reacted with a polyol, usually in the presence of a catalyst to a predetermined acid number. The unsaturated polyester can also be modified to contain urethane acrylate vinyl groups. Examples of such modifications are disclosed in U.S. Published Application 2007/0001343 the text of which is incorporated by reference herein in its entirety.

In making the gelcoat compositions, the base resin is typically diluted in the reactive diluent. In making conventional gelcoat compositions styrene is the monomer used as the diluent. Styrene, however, is a hazardous air pollutant (HAPS) and reduction of elimination of styrene is desired. Thus, in the invention alternative reactive diluents are used to replace some or all of the styrene in the reactive diluent component of the composition, processes and methods of the invention.

Preferably, the alternative reactive diluents used in this invention are linear or branched acrylics. Examples of alternative reactive diluents useful in the invention include substituted styrenes such as vinyl toluene and p-tert-butylstyrene; mono-, di-, and polyfunctional esters of monofunctional acids such as acrylic acid and methacrylic acid. Suitable acrylate monomers are the acrylic and methacrylic esters of linear and branched acyclic alcohols and polyols. Polyols are typically alcohols bearing more than a single hydroxyl group. Representative acrylate monomers include, but are not limited to, ethyl methacrylate, butyl methacrylate, butyl acrylate, hexyl acrylate, 2-ethylhexyl acrylate, lauryl acrylate, ethyl acrylate, ethylene glycol diacrylate, triethylene glycol diacrylate, tripropylene glycol diacrylate, 1,4-butanediol diacrylate and dimethacrylate, neopentyl glycol acrylate and methacrylate, 1,6-hexanediol diacrylate and dimethacrylate, 1,12-dodecanediol dimethacrylate, ethylene glycol dimethacrylate, diethylene glycol dimethacrylate, 2-ethylhexyl methacrylate, hexyl methacrylate, lauryl methacrylate, methacrylic acid, acrylonitrile, methacrylonitrile, cyanoacrylate, acrylamide and methacrylamide, polyethylene glycol diacrylate, polyethylene glycol dimethacrylate, polypropylene glycol diacrylate, polypropylene glycol dimethacrylate and combinations thereof.

The ability to replace some or all of the styrene is a function of the nature of the base resin. With the gel coat compositions comprising the base resins described herein some or all of styrene conventionally used for making gelcoat compositions can be replaced with other types of reactive diluents. For example, for formulations using unsaturated polyester resins as the base resin, the replacement diluent level used in lieu of styrene is limited to about 20%. However, if a polyester urethane (meth)acrylate or vinyl ester is used as the base resin, the replacement diluent can replace up to 100% styrene. For gelcoats used in marine/aquatic environments, the styrene level of pigmented gelcoats is preferably limited to about 40 wt % styrene or less due to emission regulations. Thus, the invention compromises an improved method for making a gel coat composition wherein the improvement compromises replacing some or all of styrene in a reactive diluent component with one or more alternative reactive diluents. The method compromises the steps of combining a base resin, such as about 40% to about 80%, preferably about 50% to about 70% base resin, with a reactive diluent component having one or more reactive diluents, such as any of those reactive diluents, including alternative reactive diluents, discussed herein. Typically, styrene is not among the reactive diluents used in this improved method. In addition to the base resin and reactive diluents, other materials may be added such as inorganic extended fillers, other fillers, pigments, and other materials as described herein. In an embodiment, the method comprises inclusion of more than about 2%, such as more than about 3% percent or about 4%, like at least about 5%, typically at least about 7%, and preferably about 5% to about 40%, most preferably about 10% to about 30% or about 5% to about 20% inorganic extended filler. The components of the gelcoat composition may be blended by processes that should be familiar to one skilled in the art.

In embodiments of the invention the reactive diluent component does not comprise styrene, however, the overall composition may comprise styrene because the base resin may comprise styrene. For example, UPR base resin comprises stryene, as much as up to about 29% styrene.

Inorganic extender fillers used in the gelcoat compositions (formulations), methods and processes described herein, include chopped or milled fiberglass, talc, silicon dioxide, titanium dioxide, wollastonite, mica, alumina trihydrate, clay, calcium carbonate, magnesium carbonate and calcium carbonate, and combinations thereof. The fillers can be used as is or be modified through surface treatment, an example of which is talc that has been surface treated to have vinyl groups. The filler is present in amounts of more than about 2%, such as more than about 3% or about 4%, like at least about 5%, typically at least about 7%, and preferably about 10% to about 45%, most preferably about 10% to about 30% or about 5% to about 20%, based on the total weight of the gelcoat formulation.

Pigments used in the gelcoat compositions, methods, and processes impart color and opacity to the gelcoat composition. Examples of pigments include treated or untreated organic or inorganic pigments and mixtures thereof, such as titanium dioxide, carbon black, iron oxide black, phthalo blue, phthalo green, quinacridone magenta, LF orange, arylide red, quinacridone red, red oxide and other pigments familiar to those skilled in the art. Pigments are used in an amount sufficient to provide an opaque cured coating composition at the desired thickness level. Combinations of pigments may be used.

Promoters used in the gelcoat compositions, methods and processes of the invention are generally any electron donating species that facilitates in the decomposition of an initiator and may also help in decomposition of any catalyst. An accelerator when used in the gelcoat compositions may also have the same function. Suitable promoters include metal compounds, for example cobalt, manganese, potassium, iron, vanadium, copper and aluminum salts of organic acids and the like; amines, for example dimethylaniline, diethylaniline, phenyl diethanolamine, dimethyl paratoluidine, 2-aminopyridine and the like; amides, for example dimethyl acetoamide, diethyl acetoamide and the like; Lewis acids, for example boron fluoride dehydrate, ferric chloride and the like; bases, for example tetramethyl ammonium hydroxide and the like; quaternary ammonium salts for example trimethyl benzyl ammonium chloride, tetrakismethylol phosphonium chloride and the like; sulfur compounds, for example dodecyl mercaptan, 2-mercaptoethanol and the like; dimethyl acetoacetamide; ethyl acetoacetate; and methyl acetoacetate. Combinations of promoters and accelerators may be used.

Thixotropic agents useful in the gelcoat compositions, methods, and processes include silica compounds and/or inorganic clays. For example, the silica compounds may be selected from the group consisting of fumed silica, hydrophilic fumed silica, hydrophobic fumed silica, precipitated silica and the like and combinations thereof. Useful inorganic clays include bentonite clay, garamite clay, hectorite clay and the like and the combinations thereof.

Inhibitors, such as, free-radical inhibitors/scavengers may be included in the gelcoat compositions and applied in the methods and processes described herein. The inhibitors may maintain an acceptable shelf life for the composition. Examples of suitable inhibitors include quinones, for example hydroquinone, toluhydroquinone, mono-tertiary-butyl hydroquinone, di tertiary-butyl hydroquinone, naptha-quinone, monomethyl ether hydroquinone and the like; butylated hydroxy toluene and tertiary butyl catechol, and the like. Combinations of inhibitors may be used.

Air release agents, also known as defoamers, will enhance the ability of the gelcoat composition to be free of trapped air, i.e. porosity. These agents may be silicone based or non-silicone based and includes acrylic polymer, hydrophobic solids, mineral oils and the like. Air release agents available from BYK Chemie, GmbH, Wesel, Germany (“BYK Chemie”) under the designations BYK-066, BYK-077, BYK-500, BYK-501, BYK-515, and BYK-555 may be used. Combinations of air release agents may be used.

Flow and leveling agents decrease the surface tension at the surface of the cured gelcoat. Surfactants, such as silicone surfactants and/or fluorocarbon surfactants are typically used in the gelcoat compositions, methods and processes described herein. Silicone surfactants that may be used in the invention include dimethyl silicones, liquid condensation products of dimethylsilane diol, methyl hydrogen polysiloxanes, liquid condensation products of methyl hydrogen silane diols, dimethysilicones, aminopropyltriethoxysilane, methyl hydrogen polysiloxanes and the like and combinations thereof. Suitable fluorocarbon surfactants include fluorinated potassium alkyl carboxylates, fluorinated alkyl quaternary ammonium iodides, ammonium perfluoroalkyl carboxylates, fluorinated alkyl polyoxyethylene ethanol, fluorinated alkyl alkoxylates, fluorinated alkyl esters, ammonium perfluoroalkyl sulfonate and the like and combinations thereof.

Dispersing aids prevent the sedimentation of mineral fillers, such as talc, aluminum trihydrate, and the like, and the flocculation of organic and inorganic pigments. Typical dispersing aids useful in the invention are surfactant polymers, for example polyester and polysiloxane copolymers, alkylol ammonium salts, and salts of unsaturated polyamine amides and acidic polyesters and the like and combinations thereof. Dispersing aids available from BYK Chemie under the designation BYK-940 may be used.

Other components commonly used and known in the art can optionally be present in the invention. These components include but are not limited to biocides, suppressants to reduce VOC emissions and catalysts. Catalysts may include materials that are inert in the gelcoat composition but become active during the application process, such as radiation-activated initiators and heat activated catalysts. Alternatively, catalysts, such as free radical catalysts like peroxide catalysts or azoalkane-type catalysts, may be used with the gelcoat compositions at the time of application.

The gelcoats can be prepared by any known means for example by blending the base resin with the remaining ingredients in any convenient order and such blending preparation may be applied in the improved methods and processes discussed herein. The gelcoat compositions described herein can be used to provide blush free parts for marine/aquatic applications.

The gelcoat compositions described herein are used in conjunction with structural materials, such as fiber glass and laminating resin to make fiber reinforced components or parts, for use in making items. One item particularly suitable for the gelcoat compositions is fiber reinforced components for watercraft, such as yachts, boats, jet skis and the like, particularly hulls or other parts of watercraft that are fully or partially submerged in water. Other items which may comprise fiber reinforced components comprising the gelcoat compositions described herein include recreational vehicles, trailers, and outdoor signage.

Methods for making watercraft with the gelcoats of the invention will generally compromise the steps of applying the gelcoat compositions described herein to an inner surface of a watercraft mold, at least partially curing the gelcoat composition, applying reinforcing material and laminating resin to the gelcoat composition within the mold to form a plastic support adjacent to the gelcoat and curing the plastic support within the mold to form a laminated fiber reinforced component comprising a fully cured gelcoat and a plastic support and demolding the laminated reinforced component. The laminated reinforced component 1 within the mold 2 is shown in FIG. 1 comprising the gelcoat composition 3 having a first side 4 adjacent to the mold 2 and a second side 5 having adjacent thereto the plastic support 6. In embodiments of the invention, the gelcoat composition is fully cured before the reinforcing material and laminating resin are applied.

The gel coat compositions comprising colored pigment (i.e. colored gel coats as opposed to white gel coats) of the invention will have lower blush values than corresponding gel coats that do not compromise the alternative reactive diluents as described herein. For example, the colored gel coat compositions will have a blush (DE) after being submerged in water of about 65° for about 6 hours then remaining in the water for about 14 hours as the water cools to room temperature of less than about 2.20, such as less than about 1.5 and typically less than about 0.95. For example, the colored gel coat compositions may have a blush of about 0.1 to about 2, such as about 0.5 to about 1.5, including ranges of about 0.10 to about 0.90, about 0.10 to about 0.65, and about 0.20 to about 0.50 after being submerged in water of about 650 for about 6 hours then remaining in the water for about 14 hours as the water cools to room temperature. White gel coats in accordance with the invention will have yellowing (Db) of less than about 3.15, such as about 1.0 to about 3.0 or about 2.0, typically about 1.2 to about 1.5, measured after being subjected to about 2,500 hours of QUV accelerated weathering performed in accordance with ASTM standard G153. ASTM G153 is incorporated herein by reference in its entirety.

In addition, incorporation of the alternative reactive monomers reduces the HAPS level of the gel coat composition to less than about 30%. For example, the HAPS level of colored gel coat composition may be less than about 28%, such as about 10% to about 25% and typically about 15% to about 20%. With the white gelcoats, the HAPS levels are decreased to less than about 30%, such as less than about 25%, for example, from about 15% to about 25%.

### EXAMPLES

In the following examples, the gel coat composition comprises a reactive diluent component which comprises and/or contains one or more alternative reactive diluent monomers and/or styrene (which may form part of the reactive diluent component). The invention requires less styrene in the reactive diluent component than if the styrene is the only reactive monomer. Thus, the alternative reactive diluent monomer(s) substitute all or part of the amount of styrene that would be necessary in the reactive diluent component if the only monomer used as a reactive monomer is styrene.

### Example 1

Gelcoat compositions, having the compositions set forth in Table 1 were prepared for this example. All amounts in Table I are in weight percent based on the total weight of the gelcoat composition, except where noted.

The alternative reactive diluent monomers used in the gelcoat compositions in place of the styrene as reactive diluent in this example are methymethacrylate, 1,6-hexanediol diacrylate, 1,6-hexanediol dimethacrylate, n-butylmethacyrlate, n-butyl acrylate, cyclohexylmethacrylate, 2-ethylhexylmethacrylate, tetrahydrofurfuryl-methacrylate, isobornyl acrylate, and isobornyl methacrylate. In the set of experiments, E1 is a control with only styrene used as a reactive diluent and all other formulations are experimental. Each formulation contains 64 wt % of an end-capped unsaturated polyester resin (S876) diluted in about 30 wt % styrene, that is the base resin comprises 30% styrene. The unsaturated polyester resin is derived from neopentyl glycol, 2-butyl-2-ethyl-1,3-propanediol, propylene glycol, isophthalic acid, and maleic anhydride. Also, each gelcoat formulation contains 1.80 wt % fumed silica, 16.7 wt % aluminum trihydrate (ATH) and 10 wt % of LP6303 which is a dark phthalo blue pigment with a low molecular weight unsaturated polyester resin grinding vehicle. The grinding vehicle is based upon dipropylene glycol and maleic anhydride.

The gelcoat formulations were prepared by, first, mixing, with a high speed mixer equipped with a cowles blade the base resin, first reactive diluent charge, inhibitor solution, and dispersing aid. After thorough mixing, the fillers were added and the high speed mixing continued until a temperature between 100° F. (38° C.) and 120° F. (49° C.) was reached. The dispersion of the fillers was checked using a Hegman grind bar which provides a measurement of the largest filler particle size. When the largest filler particle size was determined to be below about 50 microns, the remaining components of the formulations were added and mixed according to the formulation order. When building a gelcoat batch, a critical step is dispersing the fillers. If the viscosity of the media used to disperse the fillers is not correct the fillers will not disperse well. In the examples, the reactive diluent charge is split with some of the reactive diluent being added to the base resin. If some of the reactive diluent is not added to the base resin, when the fillers are being dispersed the viscosity will become too high to mix. If all of the reactive diluent is added to the base resin before dispersing the fillers, the viscosity will be too low and the fillers will not disperse well. Splitting the reactive diluent charge as shown in Table I below is a common practice in the manufacture of gelcoat formulations.

All of the gelcoat formulations were sprayed onto a glass plate at a thickness of about 20 thousandths of an inch and allowed to cure. After curing, the gelcoat was reinforced with 3 plies of chopped glass fiber and a commercially available resin, AROPOL™ 8028, from Ashland Inc., Dublin, Ohio. The unsaturated oligomer in this resin, which is diluted with styrene at about 33 wt %, is primarily comprised of dicylopentadiene, maleic anhydride, ethylene glycol, and diethylene glycol. The laminating resin was allowed to cure at room temperature.

After curing, the gelcoated composite, while still attached to the glass, was placed in an oven and post-cured for 4 hrs at 71° C. After post-curing, the composite panel was allowed to cool to room temperature and removed from the glass plate. The gelcoat was a dark blue color.

The panel was cut into two 2″×2″ squares and initial color readings were taken using a color spectrophotometer. The samples were submerged into a 65° C. water bath for 6 hrs and, with the samples still submerged in it, the water bath was allowed to cool to room temperature over approximately 14 hours. Next, the samples were removed from the room temperature bath and patted dry with a towel. After sitting for 4 hrs at room temperature, two experiments were conducted on the samples as noted in Table 1 to ascertain the difference in color change (L, a, b) or blush is reported as DE. The larger the DE value the more the sample has lightened in color or blushed. In the first set of experiments all of the alternative reactive diluent monomers, with a linear alkyl or a branched alkyl chain, reduced blushing by about 20% or greater with alternative reactive diluent monomers such as 1,6-hexanediol diacrylate, 1,6-hexanediol dimethacrylate and n-butyl methacrylate having the greatest positive impact on blush. The same general trend that the alternative reactive diluents reduce color change due to blushing is shown in the second set of experiments although the blush values over all in the control (E1) and the other formulations are higher than in the first set of experiments and the data in the second set of experiments shows anomalies for certain alternative reactive diluents when compared to the first set of experiments.

The formulations containing the alternative reactive diluent monomers were sprayed on a glass panel to 40 thousandths of an inch in thickness and checked for porosity and resistance to sag. It was observed that the cured films did not sag and after sanding into the films for 120 seconds no porosity was observed.

TABLE I

| | | Experiment #: | | | | | |
|---|---|---|---|---|---|---|---|
| | | E1 | E2 | E3 | E4 | E5 | E6 |
| | Factor: | | | | | | |
| Formulation Components | 1.0 | 3.20 | 3.20 | 3.20 | 3.20 | 3.20 | 3.20 |
| Total Parts of Resin | 63.9700 | | | | | | |
| S876 (UPR Resin) | | 204.70 | 204.70 | 204.70 | 204.70 | 204.70 | 204.70 |
| Styrene | 7.0000 | 22.40 | | | | | |
| Methylmethacrylate | 7.0000 | | 22.40 | | | | |
| 1,6-Hexanediol Diacrylate | 7.0000 | | | 22.40 | | | |
| 1,6-Hexanediol Dimethacrylate | 7.0000 | | | | 22.40 | | |
| Butylmethacrylate | 7.0000 | | | | | 22.40 | |
| Butylacrylate | 7.0000 | | | | | | 22.40 |
| Cyclohexylmethacrylate | 7.0000 | | | | | | |
| 2-ethylhexylmethacrylate | 7.0000 | | | | | | |
| Tetrahydrofurfuryl Methacrylate | 7.0000 | | | | | | |
| Isobornyl Acrylate | 7.0000 | | | | | | |
| Isobornyl Methacrylate | 7.0000 | | | | | | |
| BYK 940 | 0.2500 | 0.80 | 0.80 | 0.80 | 0.80 | 0.80 | 0.80 |
| CS8686 | 0.2500 | 0.80 | 0.80 | 0.80 | 0.80 | 0.80 | 0.80 |
| Aerosil 200 | 1.8000 | 5.76 | 5.76 | 5.76 | 5.76 | 5.76 | 5.76 |
| ATH 932 | 16.7000 | 53.44 | 53.44 | 53.44 | 53.44 | 53.44 | 53.44 |
| Styrene | 8.0000 | 25.60 | | | | | |
| Methylmethacrylate | 8.0000 | | 25.60 | | | | |
| 1,6-Hexanediol Diacrylate | 8.0000 | | | 25.60 | | | |
| 1,6-Hexanediol Dimethacrylate | 8.0000 | | | | 25.60 | | |
| Butylmethacrylate | 8.0000 | | | | | 25.60 | |
| Butylacrylate | 8.0000 | | | | | | 25.60 |
| Cyclohexylmethacrylate | 8.0000 | | | | | | |
| 2-ethylhexylmethacrylate | 8.0000 | | | | | | |
| Tetrahydrofurfuryl-Methacrylate | 8.0000 | | | | | | |
| Isobornyl Acrylate | 8.0000 | | | | | | |
| Isobornyl Methacrylate | 8.0000 | | | | | | |
| Adogen 462 | 0.0700 | 0.22 | 0.22 | 0.22 | 0.22 | 0.22 | 0.22 |
| Tween 20 | 0.3000 | 0.96 | 0.96 | 0.96 | 0.96 | 0.96 | 0.96 |
| BYK 500 | 1.0000 | 3.20 | 3.20 | 3.20 | 3.20 | 3.20 | 3.20 |
| Cobalt 12% | 0.2500 | 0.80 | 0.80 | 0.80 | 0.80 | 0.80 | 0.80 |
| Cobalt 21% | 0.0600 | 0.19 | 0.19 | 0.19 | 0.19 | 0.19 | 0.19 |
| DMAA | 0.3500 | 1.12 | 1.12 | 1.12 | 1.12 | 1.12 | 1.12 |
| Total | 100.0000 | 320.00 | 320.00 | 320.00 | 320.00 | 320.00 | 320.00 |
| HAP level | | 33.55% | 33.55% | 18.55% | 18.55% | 18.55% | 18.55% |
| % Styrene | | 33.55% | 18.55% | 18.55% | 18.55% | 18.55% | 18.55% |
| Filler loading | | 18.50% | 18.50% | 18.50% | 18.50% | 18.50% | 18.50% |
| Pigment Paste | LP6303 | 35.56 | 35.56 | 35.56 | 35.56 | 35.56 | 35.56 |
| 1st Set of Experiments (7536-3) | Blush (DE) | 0.97 | 0.37 | 0.15 | 0.15 | 0.13 | |
| 2nd Set of Experiments (7626-14) | Blush (DE) | 2.28 | 3.49 | 0.60 | 0.86 | 1.77 | 0.87 |

| | Experiment #: | | | | | |
|---|---|---|---|---|---|---|
| | E7 | E8 | E9 | E10 | E11 | |
| | Factor: | | | | | |
| Formulation Components | 3.20 | 3.20 | 3.20 | 3.20 | 3.20 | Masterbatch |
| Total Parts of Resin | | | | | | |
| S876 (UPR Resin) | 204.70 | 204.70 | 204.70 | 204.70 | 204.70 | 2364.33 |
| Styrene | | | | | | |
| Methylmethacrylate | | | | | | |
| 1,6-Hexanediol Diacrylate | | | | | | |
| 1,6-Hexanediol Dimethacrylate | | | | | | |
| Butylmethacrylate | | | | | | |
| Butylacrylate | | | | | | |
| Cyclohexylmethacrylate | 22.40 | | | | | |
| 2-ethylhexylmethacrylate | | 22.40 | | | | |
| Tetrahydrofurfuryl Methacrylate | | | 22.40 | | | |
| Isobornyl Acrylate | | | | 22.40 | | |
| Isobornyl Methacrylate | | | | | 22.40 | |
| BYK 940 | 0.80 | 0.80 | 0.80 | 0.80 | 0.80 | 9.24 |
| CS8686 | 0.80 | 0.80 | 0.80 | 0.80 | 0.80 | 9.24 |
| Aerosil 200 | 5.76 | 5.76 | 5.76 | 5.76 | 5.76 | 66.53 |
| ATH 932 | 53.44 | 53.44 | 53.44 | 53.44 | 53.44 | 617.23 |
| Styrene | | | | | | |
| Methylmethacrylate | | | | | | |
| 1,6-Hexanediol Diacrylate | | | | | | |
| 1,6-Hexanediol Dimethacrylate | | | | | | |
| Butylmethacrylate | | | | | | |
| Butylacrylate | | | | | | |
| Cyclohexylmethacrylate | 25.60 | | | | , | |
| 2-ethylhexylmethacrylate | | 25.60 | | | | |
| Tetrahydrofurfuryl-Methacrylate | | | 25.60 | | | |
| Isobornyl Acrylate | | | | 25.60 | | |
| Isobornyl Methacrylate | | | | | 25.60 | |
| Adogen 462 | 0.22 | 0.22 | 0.22 | 0.22 | 0.22 | 2.59 |
| Tween 20 | 0.96 | 0.96 | 0.96 | 0.96 | 0.96 | 11.09 |
| BYK 500 | 3.20 | 3.20 | 3.20 | 3.20 | 3.20 | 36.96 |
| Cobalt 12% | 0.80 | 0.80 | 0.80 | 0.80 | 0.80 | 9.24 |
| Cobalt 21% | 0.19 | 0.19 | 0.19 | 0.19 | 0.19 | 2.22 |
| DMAA | 1.12 | 1.12 | 1.12 | 1.12 | 1.12 | 12.94 |
| Total | 320.00 | 320.00 | 320.00 | 320.00 | 320.00 | 3298.68 |
| HAP level | 18.55% | 18.55% | 18.55% | 18.55% | 18.55% | |
| % Styrene | 18.55% | 18.55% | 18.55% | 18.55% | 18.55% | |
| Filler loading | 18.50% | 18.50% | 18.50% | 18.50% | 18.50% | |
| Pigment Paste | 35.56 | 35.56 | 35.56 | 35.56 | 35.56 | |
| 1st Set of Experiments (7536-3) | 0.30 | 0.12 | 0.77 | 0.57 | 2.73 | |
| 2nd Set of Experiments (7626-14) | 3.56 | 1.33 | 2.54 | 3.74 | 5.46 | |

In the table above the total styrene level was calculated based on the amount of styrene in the base resin, which in this case was about 29 wt %, plus any additional styrene that was added. For example, total styrene level in E1=(63.97*0.29+7+8)/100=0.3355=33.55%.

### Example 2

Gelcoat compositions compromising reactive diluent monomers, as set forth in Table II were prepared for this example. All amounts in Table II are in weight percent based on the total weight of the gelcoat composition, except where noted.

The alternative reactive diluent monomer used in the gelcoat compositions in place of the styrene in this example is 1,6-hexanediol diacrylate (HDDA). Formulations E1 and E2 contain about 64 wt % of the same unsaturated polyester resin (S876) used in Example 1, and formulation E3 contains about 59 wt %. E1 is a control having only styrene as the reactive diluent and E2 and E3 are experimental using the 1,6-hexanediol diacrylate (HDDA). Also, each gelcoat formulation contains 1.80 wt % fumed silica, 16.7 wt % aluminum trihydrate (ATH), and 10 wt % of LP6303 which is a dark phthalo blue pigment with a low molecular weight unsaturated polyester resin grinding vehicle.

The gelcoat formulations and cured test panels were prepared as set forth in Example 1. Also, blush testing was completed using the same procedure as applied in Example 1. The data in Table II demonstrates that increasing the level of HDDA from 5 to 20 wt % reduces blush by greater than 50%.

TABLE II

| | | Exp. ID Number | | |
|---|---|---|---|---|
| | | 7536-8 | | |
| | | Experiment #: | | |
| | | E1 | E2 | E3 |
| | Factor: | | | |
| Formulation Components | 1.0 | 4.00 | 4.00 | 4.00 |
| Total Parts of Resin | 63.9700 | 255.88 | 255.88 | |
| S876 (UPR Resin) | 58.9700 | | | 235.88 |
| Styrene | 10.0000 | 40.00 | | |
| | 0.0000 | | 0.00 | 0.00 |
| BYK 940 (Dispersing Aid) | 0.2500 | 1.00 | 1.00 | 1.00 |
| CS8686 (Inhibitor Solution) | 0.2500 | 1.00 | 1.00 | 1.00 |
| Aerosil 200 (Fumed Silica) | 1.8000 | 7.20 | 7.20 | 7.20 |
| (Thixotropic Filler) | | | | |
| ATH 932 (Aluminum Trihydrate) | 16.7000 | 66.80 | 66.80 | 66.80 |
| HDDA | 5.0000 | 20.00 | | |
| | 15.0000 | | 60.00 | |
| | 20.0000 | | | 80.00 |
| Adogen 462 (Cationic Inhibitor) | 0.0700 | 0.28 | 0.28 | 0.28 |
| Tween 20 (Thixotropic Syntergist) | 0.3000 | 1.20 | 1.20 | 1.20 |
| BYK 500 (Air Release) | 1.0000 | 4.00 | 4.00 | 4.00 |
| Cobalt 12% (Reactivity Promoter) | 0.2500 | 1.00 | 1.00 | 1.00 |
| Cobalt 21% (Reactivity Promoter) | 0.0600 | 0.24 | 0.24 | 0.24 |
| DMAA (Dimethylacetoacetamide) | 6.3500 | 1.40 | 1.40 | 1.40 |
| (Gellation Accele [symbol] | | | | |
| Total | 100.0000 | 400.00 | 400.00 | 400.00 |
| HAP level | | 28.55% | 18.55% | 17.10% |
| % Styrene | | 28.55% | 18.55% | 17.10% |
| Filler loading | | 18.50% | 18.50% | 18.50% |
| Pigment Paste | LP6303 | 44.44 | 44.44 | 44.44 |
| | Blush (DE) | 1.30 | 0.27 | 0.48 |

[symbol]

indicates data missing or illegible when filed

### Example 3

White gelcoat compositions compromising alternative reactive diluent monomers, as set for in Table III, were prepared in this example. All amounts in Table III are in weight percent based on the total weight of the gelcoat composition, except where noted.

The alternative reactive monomers used in the gelcoat formulations in place of the styrene in this example are 1,6-hexanediol diacrylate (HDDA) and n-butylmethacyrlate (n-BMA). In the set of experiments, E1 is a control with only styrene used as a reactive diluent and all other formulations (E2 and E3) are experimental. Each formulation contains 51.2 wt % of an end-capped unsaturated polyester resin (S570) diluted in about 30 wt % styrene. The unsaturated polyester resin is derived from neopentyl glycol, 2-butyl-2-ethyl-1,3-propanediol, propylene glycol, isophthalic acid, and maleic anhydride. Also, each gelcoat formulation contains 1.5 wt % fumed silica, 18.0 wt % titanium dioxide, 6.0 wt % aluminum trihydrate, and 6.0 wt % talc.

The gelcoat formulations in Table III were prepared using the same procedure as set forth in Example 1. Also, gelcoated panels were prepared and post-cured for testing using the laminating procedure applied in Example 1.

After removing from the glass plate, two 3″×6″ samples were cut from each panel. Initial color and gloss measurements were taken using a color spectrophotometer and a gloss meter, respectively. The samples were then placed in a Q-Lab QUV accelerated tester and tested according to the ASTM G153 procedure. The samples were removed from the QUV tester every 500 hrs to measure percent gloss retention and color change. The color change is measured in terms of L, a, b, c, and E. White gelcoats most often experience yellowing color change in the marine environment. Therefore, the greatest emphasis is placed on measuring the Db (yellowing) when conducting weathering testing. As the Db value increases, this indicates an increase in yellowing.

The formulations containing the two alternative monomers (E2 and E3) improved the gloss retention and yellowing (Db) relative to the control sample (E1) after 3,000 hrs of weathering. The two experimental formulations (E2 and E3) were sprayed to 40 thousandths of an inch in thickness and checked for porosity and resistance to sag. It was observed that the cured films did not sag and after sanding into the films for 120 seconds no porosity was observed.

TABLE III

| | | E1 | E2 | E3 |
|---|---|---|---|---|
| | Factor | | | |
| Formulation Components | 1.0 | 1.00 | 1.00 | 1.00 |
| S570 (UPR Resin) | 51.2300 | 51.23 | 51.23 | 51.23 |
| BYK 940 (Dispersing Aid) | 0.5000 | 0.50 | 0.50 | 0.50 |
| Copper 8% (Inhibitor Solution) | 0.0100 | 0.01 | 0.01 | 0.01 |
| CS8686 (THQ-HQ Inhibitor Solution) | 0.3000 | 0.30 | 0.30 | 0.30 |
| Styrene | 5.0000 | 5.00 | 5.00 | 5.00 |
| CR826 (Titanium Dioxide) | 18.0000 | 18.00 | 18.00 | 18.00 |
| Aerosil 200 (Fumed Silica) | 1.5000 | 1.50 | 1.50 | 1.50 |
| Micral 932 (Aluminum Trihydrate) | 6.0000 | 6.00 | 6.00 | 6.00 |
| Microtalc 1250 (Talc) | 6.0000 | 6.00 | 6.00 | 6.00 |
| Styrene | 10.0000 | 10.00 | | |
| HDDA | 10.0000 | | 10.00 | |
| n-BMA | 10.0000 | | | 10.00 |
| Adogen 462 (Quaternary Ammonium Salt) | 0.0700 | 0.07 | 0.07 | 0.07 |
| Tween 20 (Thixotropic Synergist) | 0.2000 | 0.20 | 0.20 | 0.20 |
| BYK 306 (Flow and Leveling) | 0.2000 | 0.20 | 0.20 | 0.20 |
| BYK 500 (Air Release) | 0.5000 | 0.50 | 0.50 | 0.50 |
| Cobalt 12% (Reactivity Promoter) | 0.1500 | 0.15 | 0.15 | 0.15 |
| Cobalt 21% (Reactivity Promoter) | 0.0400 | 0.04 | 0.04 | 0.04 |
| DMAA (Reactivity Promoter) | 0.3000 | 0.30 | 0.30 | 0.30 |
| Total | 100.0000 | 100.00 | 100.00 | 100.00 |
| HAP level | | 30.11% | 20.11% | 20.11% |
| VOC level | | 30.11% | 30.11% | 30.11% |
| % Styrene | | 30.11% | 20.11% | 20.11% |
| Filler loading | | 31.50% | 31.50% | 31.50% |
| | % Gloss Retention | 24 | 70 | 78 |
| | @ 2500 hrs | | | |
| | Db (Yellowing) | 3.30 | 1.50 | 1.20 |
| | @ 2500 hrs | | | |

We claim:

1. A gelcoat composition comprising a base resin, a reactive diluent component, a pigment and more than about 2% by weight inorganic extended filler wherein the reactive diluent component either a) comprises styrene and one or more alternative reactive diluents or b) consists of one or more alternative reactive diluents.

2. The gelcoat composition of claim 1 further comprising one or more of promoters, accelerators, thixotropic agents, inhibitors, air release agents, flow and leveling agents and dispersing aids.

3. The gelcoat composition of claim 1 wherein the alternative reactive diluent comprises one or more liner or branched chained acrylic monomers.

4. The gelcoat composition of claim 3 wherein the acrylic monomers are selected from the group consisting of ethyl methacrylate, butyl methacrylate, butyl acrylate, hexyl acrylate, 2-ethylhexyl acrylate, lauryl acrylate, ethyl acrylate, ethylene glycol diacrylate, triethylene glycol diacrylate, tripropylene glycol diacrylate, 1,4-butanediol diacrylate and dimethacrylate, neopentyl glycol acrylate, neopentyl glycol methacrylate, 1,6-hexanediol diacrylate, 1,6-hexanediol dimethacrylate, 1,12-dodecanediol dimethacrylate, ethylene glycol dimethacrylate, diethylene glycol dimethacrylate, 2-ethylhexyl methacrylate, hexyl methacrylate, lauryl methacrylate, methacrylic acid, acrylonitrile, methacrylonitrile, cyanoacrylate, acrylamide, methacrylamide, polyethylene glycol diacrylate, polyethylene glycol dimethacrylate, polypropylene glycol diacrylate, polypropylene glycol dimethacrylate and combinations thereof.

5. The gelcoat composition of claim 1 wherein the alternative reactive diluent is a substituted styrene.

6. The gelcoat composition of claim 5 wherein the substituted styrene is vinyl toluene or p-tert-butylstyrene.

7. The gelcoat composition of claim 1 wherein the base resin is selected from the group consisting of unsaturated polyester resin, urethane modified unsaturated polyester resins and vinyl ester resins.

8. The gelcoat composition of claim 1 wherein the inorganic extended filler is selected from the group consisting of chopped fiberglass, milled fiberglass, talc, silicon dioxide, titanium dioxide, wollastonite, mica, alumina trihydrate, clay, magnesium carbonate, calcium carbonate and combinations thereof.

9. The gelcoat composition of claim 1 wherein the pigment is selected from the group consisting of titanium dioxide, carbon black, iron oxide black, phthalo blue, phthalo green, quinacridone magenta, LF orange, arylide red, quinacridone red, red oxide and combinations thereof.

10. The gelcoat composition of claim 1 having a blush measured as DE of less than about 2.20 after being submerged in water at about 65° C. for about 6 hours and then remaining in the water for about 14 hours.

11. The gelcoat composition of claim 1 having yellowing measured as Db of less than about 3.15 after about 2,500 hours of QUV accelerated weathering.

12. The gelcoat composition of claim 1 wherein the HAPS level is less than about 30%.

13. The gelcoat composition of claim 1 comprising more than 3% by weight inorganic extended filler.

14. An improved process for making a gel coat composition wherein at least a base resin, a reactive diluent component comprising styrene, a pigment and inorganic extended fillers are combined the improvement comprising replacing all or some of the styrene in the reactive diluent component with one or more alternative reactive diluents.

15. The process of claim 14 wherein the alternative reactive diluent compromises one or more liner or branched chained acrylic monomers.

16. The process of claim 15 wherein the acrylic monomer is selected from the group consisting of ethyl methacrylate, butyl methacrylate, butyl acrylate, hexyl acrylate, 2-ethylhexyl acrylate, lauryl acrylate, ethyl acrylate, ethylene glycol diacrylate, triethylene glycol diacrylate, tripropylene glycol diacrylate, 1,4-butanediol diacrylate and dimethacrylate, neopentyl glycol acrylate, neopentyl glycol methacrylate, 1,6-hexanediol diacrylate, 1,6-hexanediol dimethacrylate, 1,12-dodecanediol dimethacrylate, ethylene glycol dimethacrylate, diethylene glycol dimethacrylate, 2-ethylhexyl methacrylate, hexyl methacrylate, lauryl methacrylate, methacrylic acid, acrylonitrile, methacrylonitrile, cyanoacrylate, acrylamide, methacrylamide, polyethylene glycol diacrylate, polyethylene glycol dimethacrylate, polypropylene glycol diacrylate, polypropylene glycol dimethacrylate and combinations thereof.

17. The process of claim 14 wherein the alternative reactive diluent is a substituted styrene.

18. The process of claim 14 wherein the inorganic extended filler is in an amount of more than about 2% by weight.

19. The process of claim 14 wherein all of the styrene in the reactive diluent component is replaced with one or more alternative reactive diluents.

20. A method of making a watercraft comprising the steps of applying the gelcoat composition of claim 1 to an inner surface of a watercraft mold, at least partially curing the gelcoat composition, applying reinforcing material and laminating resin to the gelcoat composition within the mold to form a plastic support adjacent to the gelcoat and curing the plastic support within the mold to form a laminated fiber reinforced component comprising a fully cured gelcoat and a plastic support and demolding the laminated reinforced component.

21. The method of claim 20 wherein the gelcoat is colored and has a blush measured as DE of less than about 2.20 after being submerged in water at about 65° C. for about 6 hours and then remaining in the water for about 14 hours.

22. The method of claim 20 wherein the gelcoat is white and has yellowing measured as Db of less than about 3.15 after being subjected to about 2,500 hours of QUV accelerated weathering.
